(19) United States
(12) Patent Application Publication
(10) Pub. No.: US 2007/0019097 A1
(43) Pub. Date: Jan. 25, 2007

(54) Image-pickup apparatus

(76) Inventor: Hajime Fukui, Tokyo (JP)

Correspondence Address: COWAN LIEBOWITZ & LATMAN P.C.;JOHN J TORRENTE, 1133 AVE OF THE AMERICAS, NEW YORK, NY, 10036, US

(21) Appl. No.: 11/483,758

(22) Filed: Jul. 10, 2006

(30) Foreign Application Priority Data
Jul. 11, 2005 (JP) 2005-202311

(51) Int. Cl. H04N 5/222

(52) U.S. Cl. 348/333.01

(57) ABSTRACT

An image-pickup apparatus is disclosed which ensures a wide range of photometric measurement in an electronic observation state and allows a reduced release time lag in image-pickup operation with flashing. The image-pickup apparatus includes an optical-path switching member, a shutter which controls the amount of exposure light to an image-pickup device, a first light-receiving element, and a control unit which disposes the optical-path switching member to a second position and opens the shutter to allow electronic observation of an object with an electronic display device, and controls light emission of a flash unit which illuminates the object. When image-pickup operation with flashing is performed in an electronic observation state, the control unit closes the shutter before the image-pickup operation with flashing, and sets an amount of light emission of the flash unit based on an output from the first light-receiving element which receives light reflected by the shutter.

### BACKGROUND OF THE INVENTION

The present invention relates to an image-pickup apparatus such as a digital single-lens reflex camera, and more particularly, to an image-pickup apparatus which can be used to pick up images with an electronic flash.

FIGS. 10 and 11 schematically show the structure of a digital single-lens reflex camera proposed by the present applicant (see Paragraphs 0013 to 0031 and FIG. 1 inJapanese Patent Laid-Open No. 9(1997)-61898). In FIGS. 10 and 11, reference numeral 801 shows a camera body, 820 an image-pickup lens (an interchangeable lens) which is removably mounted on the camera body 801, and 802 a mirror serving as an optical-path switching member which is movable to a down position (in FIG. 10) where it directs a luminous flux from the image-pickup lens 820 toward a viewfinder optical system and to an up position (in FIG. 11) where it directs the luminous flux toward an image-pickup device.

Reference numeral 803 shows a focus plate, 804 a pentaprism, and 805 an eyepiece. Reference numeral 806 shows a shutter, 807 the image-pickup device such as a CCD sensor, and 808 an image display device such as a liquid crystal display.

Reference numeral 810 shows a photometric sensor which performs photometric measurement of an object. Reference numeral 809 shows a photometric lens for focusing an object image, which was once formed on the focus plate 803 by the image-pickup lens 820, onto the photometric sensor 810. Reference numeral 821 shows an aperture which adjusts the amount of light.

Reference numeral 830 shows an external flash unit removably mounted on the camera body 801. Reference numeral 831 shows a xenon (Xe) tube. Reference numeral 832 and 833 show a reflecting cover and a Fresnel lens for collecting light emitted from the Xe tube 831 and applying the collected light to the object.

In the camera, the flash unit 830 (the Xe tube 831) preliminarily emits light immediately before image-pickup operation, and the photometric sensor 810 measures the object luminance in the preliminary light emission. Then, the deviation of the photometric result from a correct exposure based on a set aperture value, the sensitivity of the image-pickup device 807 and the like is determined, and the amount of light corresponding to the deviation is added to determine the amount of light in main image-pickup operation.

The photometric sensor 810 performs the photometric measurement through a known logarithmic compression amplifier and can cover a range of approximately 20 levels. This enables accurate photometric measurement of an object at any position from short to long distances.

Typically, in such a digital single-lens reflex camera, a user has observed an object through the viewfinder optical system. In recent years, however, users demand a function of object observation through an image display device such as a liquid crystal display (an electronic viewfinder function). The electronic viewfinder function may be realized by disposing the mirror 802 at the up position, opening the shutter 806, using the image-pickup device 807 to produce an object image, and displaying it on the image display device 808, as in the image-pickup operation shown in FIG. 11.

When the mirror 802 is disposed at the up position, however, a luminous flux cannot be directed from the image-pickup lens 820 to the photometric sensor 810 and thus the photometric measurement cannot be performed. To perform the photometric measurement in the preliminary light emission with the photometric sensor 810 after the electronic viewfinder is used, the mirror 802 needs to be moved to the down position in FIG. 10 after the position in FIG. 11 to perform the preliminary light emission and photometric measurement. After the preliminary light emission, the mirror 802 is again moved to the up position to perform image-pickup operation and the main light emission. This results in a long time period taken from the instruction for image-pickup operation to the main image-pickup operation (a long release time lag).

The photometric measurement in the preliminary light emission can be performed by using the image-pickup device 807 as the photometric sensor. A typical image-pickup device, however, has a dynamic range of approximately 8 levels and cannot achieve photometric measurement beyond that. Particularly, in view of the linearity of the output from the image-pickup device, the photometric measurement can actually be performed only in the range of four to five levels. Thus, the image-pickup device cannot support the photometric measurement of an object at any position from short to long distances.

As a result, the characteristic ability of the external flash unit to emit a large amount of light cannot be fully used.

The photometric measurement range can be increased by repeating the preliminary light emission and the photometric measurement while the amount of light is sequentially changed in the preliminary light emission until the level of brightness of the image captured in the preliminary light emission reaches the dynamic range of the image-pickup device. However, the approach also has the problem of a long release time lag.

### BRIEF SUMMARY OF THE INVENTION

It is an object of the present invention to provide an image-pickup apparatus which can ensure a wide range of photometric measurement when an electronic viewfinder is used (in an observation state with the electronic display device) and which allows a reduced release time lag when an image is picked up with an electronic flash.

According to an aspect, the present invention provides an image-pickup apparatus including an image-pickup device which photoelectrically converts an object image, an electronic display device which displays an image provided by using the image-pickup device, a viewfinder optical system, an optical-path switching member which is movable to a first position where the member directs a luminous flux from an object to the viewfinder optical system and a second position where the member directs the luminous flux from the object to the image-pickup device, a shutter which controls an amount of exposure light to the image-pickup device, a first light-receiving element, and a control unit which disposes the optical-path switching member to the second position and opens the shutter to allow observation of the object with the electronic display device and controls light emission of a flash unit which illuminates the object. When image-pickup operation with flashing is performed in an observation state with the electronic display device, the control unit closes the shutter before the image-pickup operation with flashing, and sets an amount of light emission of the flash unit based on an output from the first light-receiving element which receives light reflected by the shutter.

According to another aspect, the present invention provides an image-pickup apparatus having an image-pickup device which photoelectrically converts an object image, an electronic display device which displays an image provided by using the image-pickup device, a viewfinder optical system, an optical-path switching member which is movable to a first position where the member directs a luminous flux from an object to the viewfinder optical system and a second position where the member directs the luminous flux from the object to the image-pickup device, a photoelectric element which is disposed on an optical path from the object to the image-pickup device and has an electrically controllable transmittance, a first light-receiving element, and a control unit which disposes the optical-path switching member to the second position and sets the transmittance of the photoelectric element to a first transmittance to allow observation of the object with the electronic display device and controls light emission of a flash unit which illuminates the object. When image-pickup operation with flashing is performed in an observation state with the electronic display device, the control unit sets the transmittance of the photoelectric element to a second transmittance lower than the first transmittance before the image-pickup operation with flashing, and sets an amount of light emission of the flash unit based on an output from the first light-receiving element which receives light reflected by the photoelectric element.

### BRIEF DESCRIPTION OF THE DRAWINGS

FIG. 1 is a block diagram showing the structure of a digital single-lens reflex camera system which is Embodiment 1 of the present invention.

FIG. 2 is a flow chart showing the operation of the camera system of Embodiment 1.

FIG. 3 is a flow chart showing the operation of the camera system of Embodiment 1.

FIG. 4 is a flow chart showing the operation of the camera system of Embodiment 1.

FIG. 5 is a flow chart showing the operation of the camera system of Embodiment 1.

FIG. 6 is a flow chart showing the operation of the camera system of Embodiment 1.

FIG. 7 is a flow chart showing the operation of the camera system of Embodiment 1.

FIG. 8 is a block diagram showing the structure of a digital single-lens reflex camera system which is Embodiment 2 of the present invention.

FIG. 9 is a flow chart showing the operation of the camera system of Embodiment 2.

FIG. 10 is a section view showing the structure of a conventional digital single-lens reflex camera (in a mirror down state).

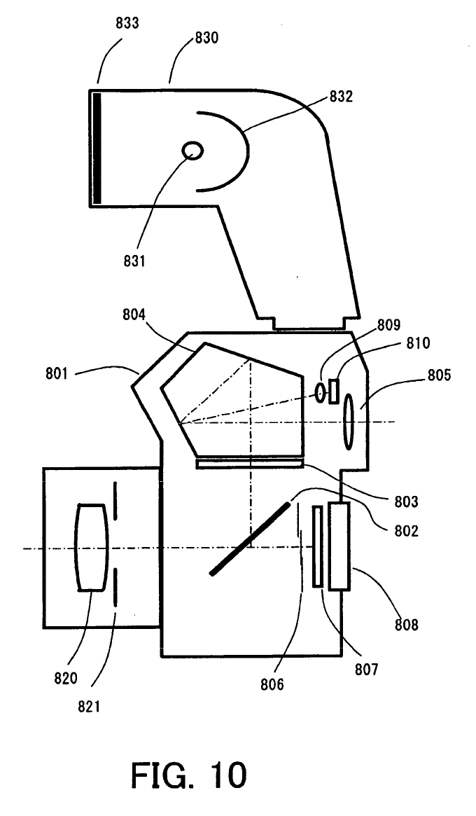

FIG. 11 is a section view showing the structure of a conventional digital single-lens reflex camera (in a mirror up state).

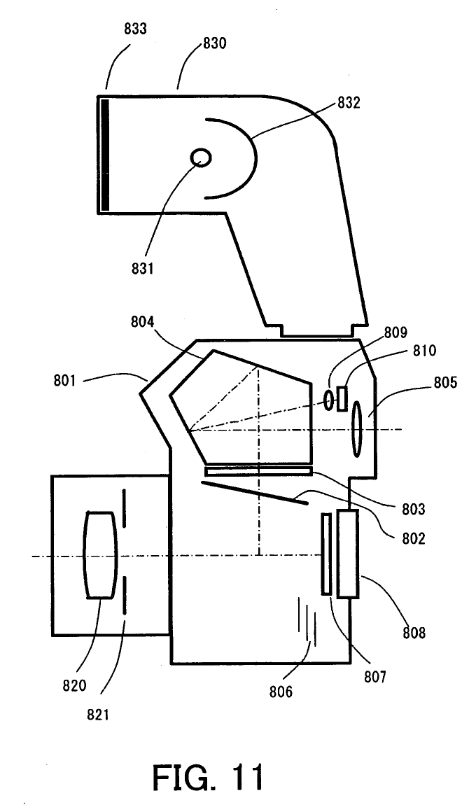

### DETAILED DESCRIPTION OF THE PREFERRED EMBODIMENTS

Preferred embodiments of the present invention will hereinafter be described with reference to the drawings.

### Embodiment 1

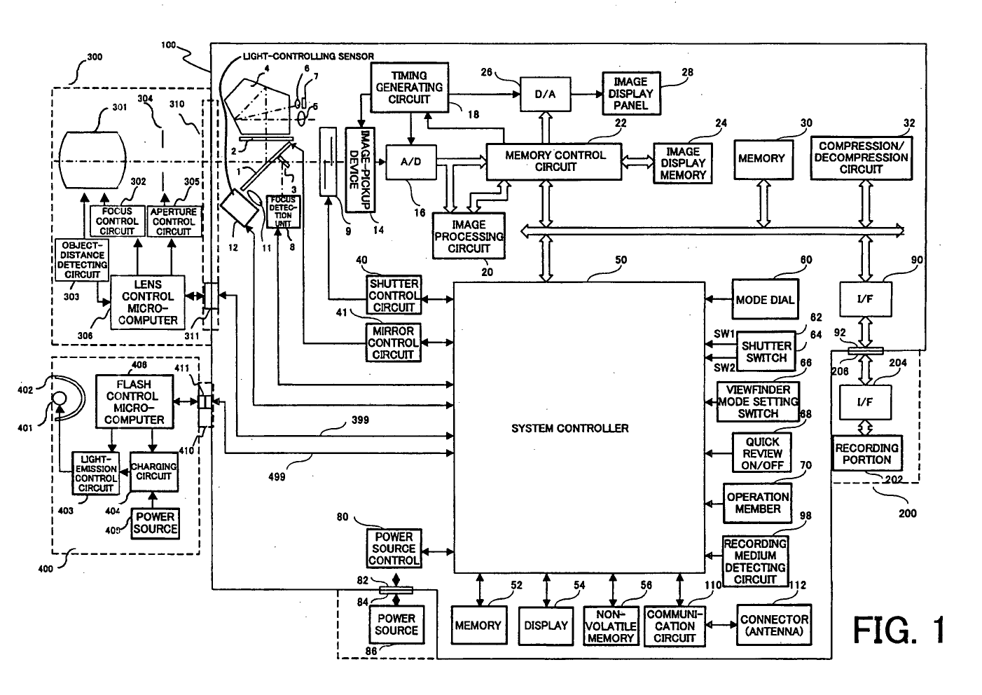

FIG. 1 shows the structure of a single-lens reflex camera system which is Embodiment 1 of the present invention. In FIG. 1, reference numeral 100 shows a digital single-lens reflex camera body (hereinafter referred to simply as a camera body) serving as an image-pickup apparatus. Reference numeral 300 shows an interchangeable image-pickup lens (hereinafter referred to simply as an image-pickup lens) removably mounted-on the camera body 100.

In the camera body 100, reference numeral 1 shows a main mirror which is disposed in an image-pickup optical path in an optical viewfinder observation state (the position will hereinafter be referred to as a down position) and is retracted from the image-pickup optical path in an electronic viewfinder observation state and in an image-pickup operation state (the position will hereinafter be referred to as an up position). The main mirror 1 is formed of a half mirror which transmits part of a luminous flux from the image-pickup lens 300 when it is disposed at the down position.

Reference numeral 2 shows a focus plate. An object image formed by the image-pickup lens 300 is then reflected by the main mirror 1 disposed in the image-pickup optical path and projected onto the focus plate 2.

Reference numeral 3 shows a submirror which is disposed at the back of the main mirror 1 disposed at the down position (the position will hereinafter referred to as a down position) in the optical viewfinder observation state and is retracted from the image-pickup optical path (the position will hereinafter be referred to as an up position) in the electronic viewfinder observation state and the image-pickup operation state similarly to the main mirror 1 disposed at the up position. In the optical viewfinder observation state, the sub mirror 3 reflects the luminous flux transmitted through the main mirror 1 downward to a focus detection unit 8, later described.

Reference numeral 4 shows a pentaprism which directs the luminous flux from the focus plate 2 toward an eyepiece 5 and a photometric sensor 7, later described. A user can see the focus plate 2 through the eyepiece 5 to observe an object image. The state will hereinafter be referred to as an optical viewfinder mode (OVF mode: optical observation state).

The photometric sensor 7 receives the luminous flux emerging from the pentaprism 4 through an image-forming lens 6. The photometric sensor 7 including a second light-receiving element outputs a signal which represents the intensity of the received light. The output is used for measuring the object luminance in a viewfinder observation image plane. The photometric sensor 7 includes a known logarithmic compression circuit and provides a logarithmically compressed output.

The focus detection unit 8 uses the luminous flux from the sub mirror 3 to form a pair of or a plurality of pairs of object images on line sensors, not shown. The focus detection unit 8 outputs a signal which represents the separation (the phase difference) between the object images. This allows focus detection in the phase difference detection method.

Reference numeral 9 shows a focal plane shutter which controls an exposure of an image-pickup device 14, later described, by moving a front curtain and a rear curtain. In Embodiment 1, as described later, photometric measurement is performed for an object image formed on the object-side surface of the front curtain (hereinafter referred to simply as a front curtain surface) in an EVF mode, so that the front curtain surface is treated for diffusing and reflecting the luminous flux incident thereon while considerations are made to avoid ghost due to irregular reflection on the front curtain surface in image-pickup operation.

The image-pickup device 14 is a photoelectrical conversion element formed of a CCD sensor, a CMOS sensor, or the like.

Reference numeral 11 shows an image-forming lens which focuses an object image formed on the front curtain surface of the focal plane shutter 9 (that is, light reflected by the front curtain surface) on a light-controlling sensor 12 including a first light-receiving element in flash light control when the main mirror 1 and the submirror 3 are disposed at the up positions. The light-controlling sensor 12 includes a known logarithmic compression circuit similarly to the photometric sensor 7 and provides a logarithmically compressed output.

Reference numeral 16 shows an A/D converter which converts an analog signal output from the image-pickup device 14 into a digital signal. Reference numeral 18 shows a timing generating circuit which supplies a clock signal and a control signal to the image pick-up device 14, the A/D converter 16, and a D/A converter 26 and is controlled by a memory control circuit 22 and a system controller 50 serving as a control unit.

Reference numeral 20 shows an image processing circuit which performs predetermined processing such as pixel interpolation processing and color conversion processing on data from the A/D converter 16 or data from the memory control circuit 22. The image processing circuit 20 performs predetermined calculation processing on the data of a picked-up image and also performs AWB (Auto White Balance) processing in a TTL method based on the calculation results.

The memory control circuit 22 controls the A/D converter 16, the timing generating circuit 18, the image processing circuit 20, an image display memory 24, the D/A converter 26, a memory 30, and a compression/decompression circuit 32 in response to an instruction from the system controller 50.

Data output from the A/D converter 16 is written into the image display memory 24 or the memory 30 via the image processing circuit 20 and the memory control circuit 22. The data output from the A/D converter 16 may be written into the image display memory 24 or the memory 30 via the memory control circuit 22.

Reference numeral 28 shows an image display panel formed of a TFT, an LCD or the like. Image data for display written into the image display memory 24 is then displayed on the image display panel 28 via the D/A converter 26.

When the main mirror 1 and the sub mirror 3 are disposed at the up positions and the shutter 9 is opened, a signal output from the image-pickup device 14 can be processed and the resulting moving image can be displayed on the image display panel 28 to realize an electronic viewfinder function. This state will hereinafter be referred to as an electronic viewfinder mode (EVF: electronic observation state).

The memory 30 is provided for storing produced still images and moving images and has a storage capacity large enough to store a predetermined number of still images and moving images for a predetermined time period. The memory 30 is also used as a work area memory for the system controller 50.

Reference numeral 32 shows the compression/decompression circuit which compresses and decompresses image data through adaptive discrete cosine transform (ADCT) or the like. The circuit 32 reads the image stored in the memory 30, performs the compression or decompression thereof, and writes the processed data into the memory 30.

Reference numeral 40 shows a shutter control circuit which controls the focal plane shutter 9. Reference numeral 41 shows a mirror control circuit which is formed of a motor and a driving circuit thereof. The motor is provided for moving the main mirror 1 and the sub mirror 3 to the up positions and the down positions.

The system controller 50 controls the overall operation of the camera body 100. Reference numeral 52 shows a memory which stores constants, variables, programs, and the like for the operation of the system controller 50.

Reference numeral 54 shows an information display unit which presents an operation state, a message and the like with letters, images, sounds or the like in response to the execution of the program in the system controller 50 and includes a sound-production element and a speaker which provide operation sounds and alarm sounds. The information display unit 54 is formed of an LCD, an LED or the like. A single or a plurality of display elements of the unit 54 are disposed at positions on the outer surface of the camera body 100 where a user can easily view. The information display unit 54 includes a display element for displaying predetermined information in a lower portion of the focus plate 2.

A display element of the information display unit 54 provided on the outer surface of the camera body 100 displays a single shot mode/continuous shot mode, a self-timer, an image compression rate, the number of pixels for recording, the number of recorded images, the number of images which can be recorded, a shutter speed, an aperture value, an exposure compensation value, flash ON, a red-eye minimizing mode, macro image-pickup operation, beeper setting, a battery indicator, date and time, and the like.

Another display element of the information display unit 54 provided in the lower portion of the flat panel 2 displays focusing, a camera-shake alarm, flash charging, a shutter speed, an aperture value, an exposure compensation value, and the like.

Reference numeral 56 shows an electrically erasable and recordable non-volatile memory, and for example, an EEPROM is used.

Reference numerals 60, 62, 64, 66, 68, and 70 show operation members for inputting instructions for various operations of the system controller 50. The operation members include a switch, a dial, and a touch panel, as well as a pointing device with detection of the line of sight and a voice recognition device.

The mode dial switch 60 is an operation member which is used to turn on/off the power source and set respective function modes such as an image-pickup mode, a reproduction mode, an erase mode, and a PC connecting mode.

The shutter switch (SW1) 62 is an operation member which is turned on by first stroke operation (half press) of a shutter button, not shown, to direct the start of preparatory operation for image pickup such as AF (auto-focus) operation and AE (auto-exposure) processing.

The shutter switch (SW2) 64 is turned on by second stroke operation (full press) of the shutter button. The turn-on of the shutter switch 64 instructs the system controller 50 to start a series of image-pickup operations. The image-pickup operations include exposure processing in which the shutter control circuit 40 and a flash unit 400 are operated to exposure the image-pickup device 14. The image-pickup operations also include reading processing by writing a signal read from the image-pickup device 14 into the memory 30 as image data via the A/D converter 16 and the memory control circuit 22. The image-pickup operations also include development processing with the calculations in the image processing circuit 20 and the memory control circuit 22 and recording processing by reading image data from the memory 30, compressing it in the compression/decompression circuit 32, and writing the image data on a recording medium 200.

The viewfinder mode setting switch 66 is operated to select one of the OVF mode and EVF mode in the image-pickup operation. The function can be used to block current supply to the image display panel 28 when an image is picked up with the optical viewfinder, which enables power saving.

The quick review ON/OFF switch 66 is an operation member for setting a quick review function to automatically reproduce the data of a picked-up image immediately after the image is picked up.

The operation section 70 has various buttons such as a menu button, a set button, a macro button, a multi-image reproduction/new-page button, a single shot/continuous shot/self timer switch button, a menu moving button, a reproduced-image moving button, an image quality selection button, an exposure compensation button, and a date and time setting button, as well as a touch panel.

Reference numeral 80 shows a power control circuit which is formed of a battery detection circuit, a DC-DC converter, a switch circuit for switching energized blocks, and the like. The power control circuit 80 detects the presence/absence of a mounted battery, the type of the battery, and the remaining battery, controls the DC-DC converter based on the detection results and the instruction from the system controller 50, and supplies necessary voltage to respective portions including the recording medium 200 for a necessary time period.

Reference numerals 82 and 84 show connectors, and 86 a power source formed of a primary battery such as an alkaline battery and lithium battery, a secondary battery such as a NiCd battery, NiMH battery, and Li battery, and an AC adapter.

Reference numeral 90 shows an interface to the recording medium 200, 92 a connector for connection with the recording medium 200, and 98 a recording medium detecting circuit for detecting whether or not the recording medium 200 is connected to the connector 92.

Reference numeral 110 shows a communication circuit which has various communication functions with RS232C, USB, IEEE1394, P1284, SCSI, a modem, LAN, wireless communication and the like. Reference numeral 112 shows a connector for connecting the camera body 100 with another apparatus through the communication circuit 110. An antenna for wireless communication may be used instead of the connector.

The recording medium 200 has a recording portion 202 which is formed of a semiconductor memory, a magnetic disk, an optical disk or the like, an interface 204 to the camera body 100, and a connector 206 for connection with the camera body 100.

Reference numeral 399 shows a communication line for communication between the image-pickup lens 300 and the system controller 50. Reference numeral 499 shows a communication line for communication between the external flash unit 400, later described, and the system controller 50.

In the image-pickup lens 300, reference numeral 301 shows an image-pickup optical system which forms an object image on the image-pickup device 14. Reference numeral 302 shows a focus control circuit which is formed of a motor and a driving circuit thereof. The motor is provided for driving a focus lens included in the image-pickup optical system 301 in the direction of an optical axis to achieve focusing.

Reference numeral 303 shows an object-distance detecting circuit which includes an encoder for detecting an object distance from the position of a lens included in the image-pickup optical system 301. Reference numeral 304 shows an aperture which adjusts the amount of light in the image pick-up operation, and 305 an aperture control circuit which is formed of a motor for driving the aperture 304 and a driving circuit thereof.

Reference numeral 306 shows a lens control microcomputer which controls the abovementioned focus driving and aperture driving and controls the communication between the image-pickup lens 300 and the system controller 50 in the camera body 100.

The image-pickup lens 300 is removably mounted on the camera body 100 via a lens mount 310 and is electrically connected to the camera body 100 via a connector 311 formed of a serial communication line and a power source line.

Reference numeral 400 shows the flash unit. Reference numeral 401 shows a xenon (Xe) tube, 402 a reflecting cover, and 403 a light-emission control circuit which is formed of an IGBT or the like for controlling the emission of light from the Xe tube 401. Reference numeral 404 shows a charging circuit which generates voltage of approximately 300 volts to be supplied to the Xe tube 401. Reference numeral 405 shows a power source such as a battery for providing power to the charging circuit 404. Reference numeral 406 shows a flash control microcomputer which controls the light emission and charging of the flash unit 400 and controls the communication between the flash unit 400 and the system controller 50.

The flash unit 400 is removably mounted on the camera body 100 via a hot shoe 410. The flash unit 400 is electrically connected to the camera body 100 via a connecter 411 which is formed of a serial communication line and an X terminal (light-emission terminal).

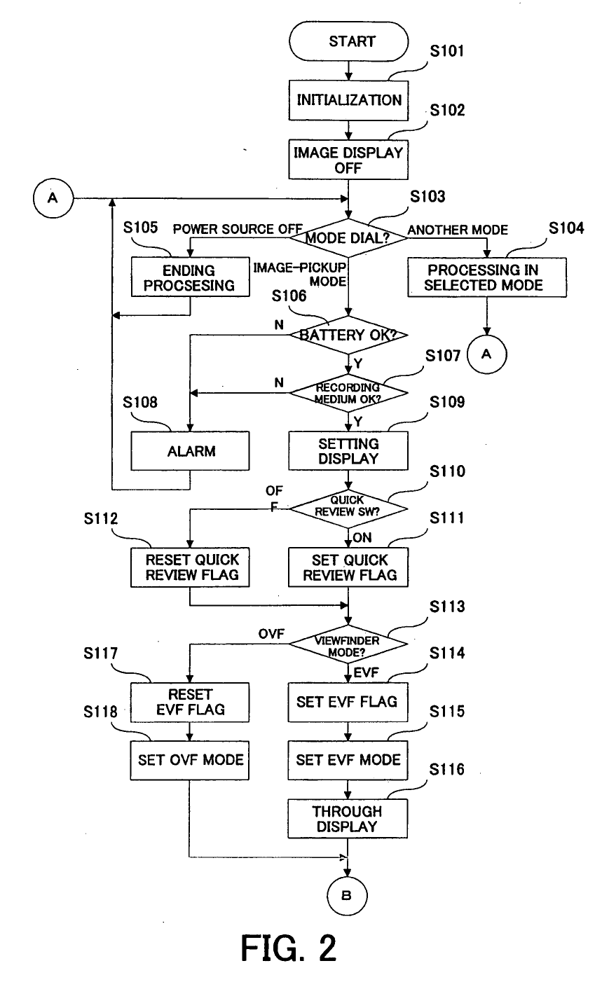

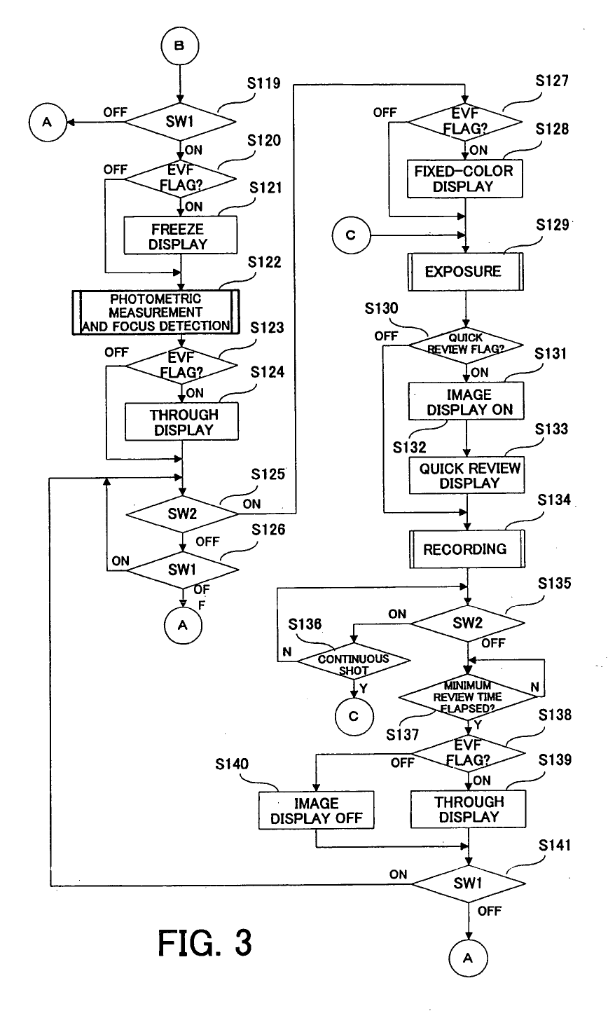

Next, the operation of the camera system of Embodiment 1 will be described with reference to FIGS. 2 to 7. FIGS. 2 and 3 show the flow chart of a main routine performed by the system controller 50 in the camera body 100 of Embodiment 1. “S” in the following description and the flow charts represents a step. In FIGS. 2 and 3, the same circled letters show that they are linked.

When the camera system is powered on by turning on the power source or putting a new battery, the system controller 50 initializes flags, control variables and the like (S101) and sets the image display on the image display panel 28 to an OFF state for initial setting (S102).

The system controller 50 determines the set position of the mode dial 60 (S103). When the mode dial 60 is set to power OFF, the system controller 50 changes the display of each display section to the end state, and records necessary parameters, set values, and set modes including the flags and control variables in the non-volatile memory 56. After the system controller 50 performs predetermined end processing such as blocking unnecessary power in each portion of the camera body 100 including the image display panel 28 through the power control circuit 80 (S105), the flow returns to step S103.

When the mode dial 60 is set to an image-pickup mode at step S104, the flow proceeds to step S106. When the mode dial 60 is set to another mode, the system controller 50 performs processing in accordance with the selected mode (S104), and when the processing is finished, the flow proceeds to step S103.

The system controller 50 determines whether or not there is any problem in the remaining capacity of the power source 86 or the operation state of the camera body 100 with the power control circuit 80 (S106). When any problem is found, it uses the information display unit 54 to provide a predetermined alarm through an image or a sound (S108). Then, the flow returns to S103.

When no problem is found in the power source 86 (S106), the system controller 50 determines whether or not the operation state of the recording medium 200 is problematic in recording/reproduction operation of image data by the camera body 100 on the recording medium 200 (S107). When any problem is found, it uses the information display unit 54 to provide a predetermined alarm through an image or a sound (S108), and then the flow returns to S103.

When no problem is found in the operation state of the recording medium 200, the system controller 50 uses the information display unit 54 to display various settings of the camera body 100 through an image or a sound (S109). When the image display of the image display panel 28 is ON, it also uses the image display panel 28 to display the various settings of the camera body 100 through an image or a sound.

Next, the system controller 50 checks the setting of the quick review ON/OFF switch 68 (S110), and sets a quick review flag if the quick review is set to ON (S111) When the quick review is set to OFF, it resets the quick review flag (S112). The quick review flag is stored in an internal memory of the system controller 50 or the memory 52.

Then, the system controller 50 checks the setting of the viewfinder mode setting switch 66 (S113), and sets an EVF flag when image display is ON (S114). The system controller 50 also sets the image display of the image display panel 28 to ON (S115) and sets a through display state for sequentially displaying the data of a picked-up image (S116). Then, the flow proceeds to S119.

In the through display state, the system controller 50 causes the data sequentially written into the image display memory 24 via the image pick-up device 14, the A/D converter 16, the image processing circuit 20, and the memory control circuit 22 to be displayed sequentially on the image display panel 28 via the memory control circuit 22 and the D/A converter 26. This realizes the electronic viewfinder function.

When the image display ON/OFF switch 66 is set to image display OFF (S113), the EVF flag is reset (S117), and the image display of the image display panel 28 is set to OFF (S118). The flow proceeds to S119.

When the image display is OFF, an image is picked up by using the optical viewfinder, not by using the electronic viewfinder function with the image display panel 28. In this case, it is possible to reduce power consumption in the image display panel 28, the D/A converter and the like which use high power. The state of the EVF flag is stored in the internal memory of the system controller 05 or the memory 52.

When the shutter switch SW1 is not pressed at S119, the flow returns to S113. When the shutter switch SW1 is pressed, the system controller 50 determines the state of the EVF flag stored in the internal memory or the memory 52 (S120). When the EVF flag is set, the system controller 50 sets the display state of the image display panel 28 to a freeze display state (S121), and the flow proceeds to S122.

In the freeze display state, rewriting of image data in the image display memory 24 through the image pick-up device 14, the A/D converter 16, the image processing circuit 20, and the memory control circuit 22 is disabled. The most recently written image data is displayed on the image display panel 28 via the memory control circuit 22 and the D/A converter 26 to display the frozen image in the electronic viewfinder.

When the EVF flat is reset at S120, the flow proceeds to S122.

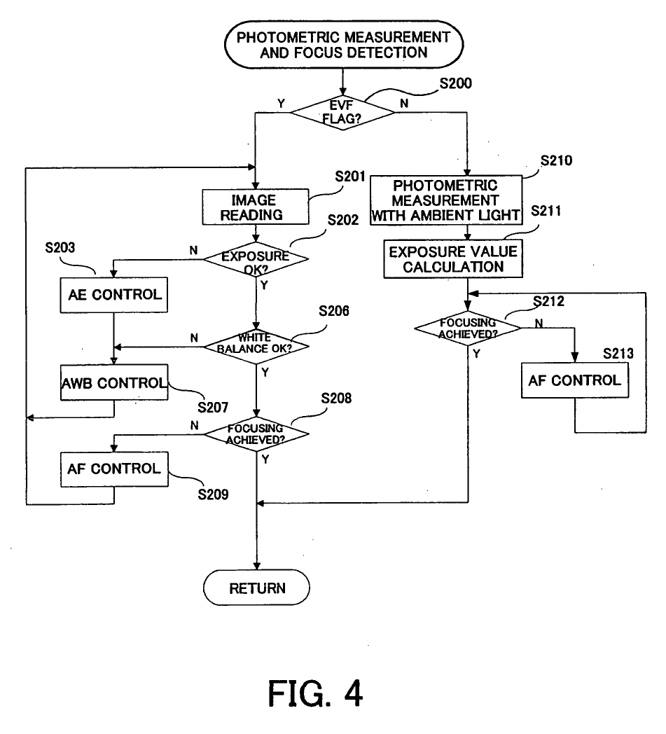

At S122, the system controller 50 performs focus detection to focus the image-pickup optical system 301 on the object, and performs photometric measurement to determine the aperture value and the shutter time (S122). The details of the photometric measurement and focus detection processing (S122) will be described later with reference to FIG. 4.

After the system controller 50 finishes the photometric measurement and focus detection processing (S122), it determines the state of the EVF flag stored in the internal memory or the memory 52 (S123). When the EVF flag is set, the system controller 50 sets the display state of the image display panel 28 to the through display state (S124), and the flow proceeds to S125. The through display at S124 is performed with the same operation as that in the through display at S116.

When the shutter switch SW2 is not pressed at S125 and the operation of the shutter switch SW1 is reset (S126) the flow returns to S103.

On the other hand, when the shutter switch SW2 is pressed at S125, the system controller 50 determines the state of the EVF flag stored in the internal memory or the memory 52 (S127). When the EVF flag is set, it sets the display state of the image display panel 28 to a fixed-color display state (S128), and the flow proceeds to S129.

In the fixed-color display state, the data of the picked-up image written to the image display memory 24 via the image-pickup device 14, the A/D converter 16, the image processing circuit 20, and the memory control circuit 22 is replaced with the fixed-color image data. The fixed-color image data is displayed on the image display panel 28 via the memory control circuit 22 and the D/A converter 26 to display the fixed-color image in the electronic viewfinder.

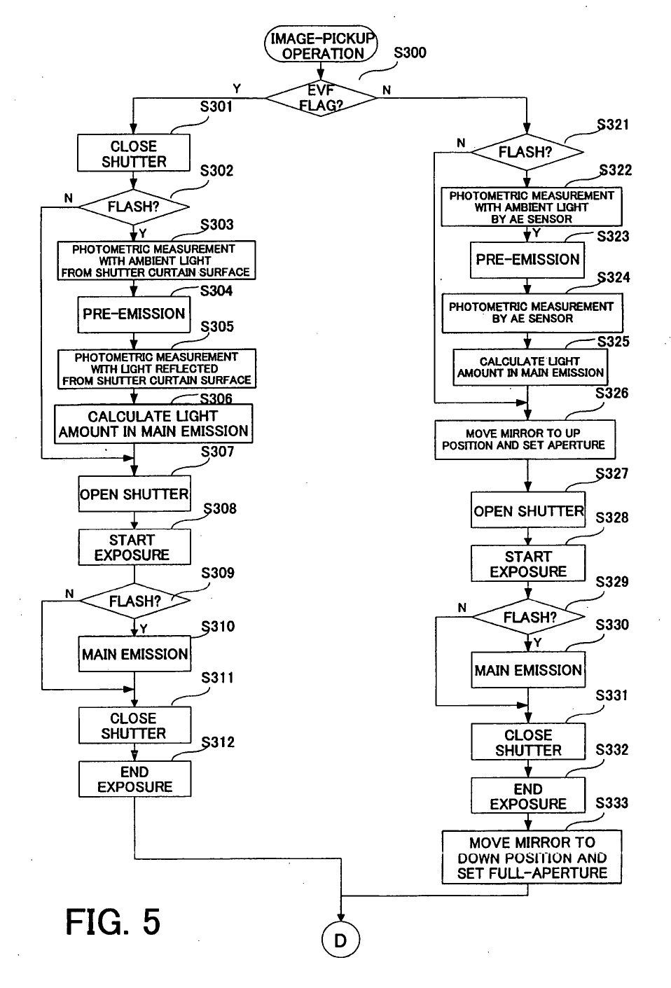

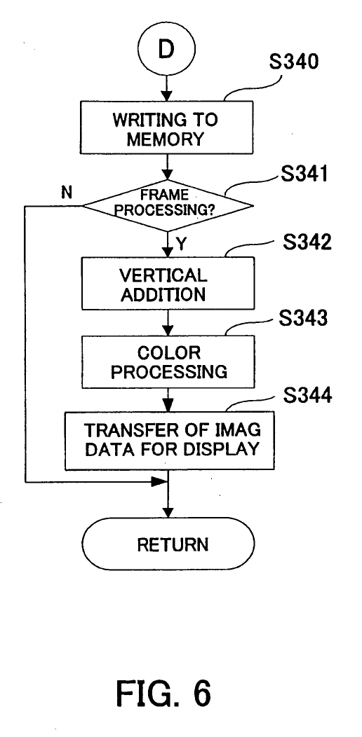

When the EVF flag is reset at S127, the flow proceeds to S129. At S129, the system controller 50 performs exposure processing and writing processing of the image-pickup device 14. The details of the exposure and writing processing (S129) will be described later with reference to FIGS. 5 and 6.

After the exposure processing, the system controller 50 determines the state of the quick review flag stored in the internal memory or the memory 52 (S130). When the quick review flag is set, the system controller 50 sets the image display of the image display panel 28 to ON (S131) to perform quick review display (S133).

When the quick review flag is not set at S130, the flow proceeds to S134.

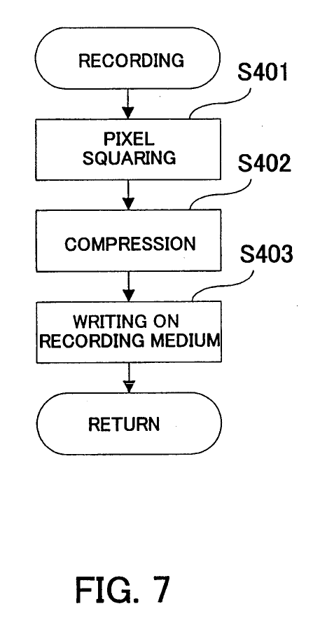

At S134, the system controller 50 reads the data of the picked-up image written into the memory 30 and performs various image processing with the memory control circuit 22 and, as required, the image processing circuit 20. After the system controller 50 performs the image compression processing using the compression/decompression circuit 32 in accordance with the set mode, it performs writing (recording processing) of the image data on the recording medium 200. The details of the recording processing (S134) will be described with reference to FIG. 7.

Upon completion of the recording processing at S134, when the shutter switch SW2 is pressed (S135), the system controller 50 determines the state of a continuous-shot flag stored in the internal memory or the memory 52 (S136). When the continuous-shot flag is set, the flow returns to step S129 for continuous exposure, and the next exposure is performed.

When the continuous-shot flag is not set (S136), the current processing is repeated until the operation of the shutter switch SW2 is released (S135).

In this manner, in Embodiment 1, when the quick review display is set and the shutter switch SW2 is pressed at the time of the end of the recording processing at S134, the quick review display is continued until the shutter switch SW2 is released. This allows a user to check the picked-up image carefully.

When the operation of the shutter switch SW2 is released at the time of the end of the recording processing at S134, the flow proceeds to S138 after the lapse of a predetermined minimum review time period (S137). When the pressing of the shutter switch SW2 is maintained at the end of the recording processing at S134 and the quick review display is continued, and then the operation of the shutter switch SW2 is released (S135), the flow proceeds to S138 after the lapse of the predetermined minimum review time period (S137).

If the EVF flag is set at S138, the system controller 50 sets the display state of the image display panel 28 to the through display state (S139), and then the flow proceeds to S141. In this case, it is possible that the user first checks the picked-up image in the quick review display on the image display panel 28 and then the through display state is entered for sequentially displaying the data of the picked-up image for the next image-pickup operation.

When the EVF flag is reset at S138, the system controller 50 sets the image display of the image display panel 28 to the OFF state (S140), and then the flow proceeds to S141. In this case, after the picked-up image is checked through the quick review display on the image display panel 28, the display on the image display panel 28 is stopped for power saving. This allows reduced power consumption in the image display panel 28: the D/A converter 26 and the like which use high power.

When the shutter switch SW1 is pressed at S141, the system controller 50 returns to S125 to prepare for the next image-pickup operation. When the operation of the shutter switch SW1 is released (S141), the system controller 50 finishes the series of image-pickup operations and returns to S103.

FIG. 4 shows a flow chart which represents the details of the photometric measurement and focus detection processing at S122 of FIG. 3. At S200, the system controller 50 determines whether or not the EVF flag is set. When the EVF flag is set, the system controller 50 reads a charge signal from the image-pickup device 14 and sequentially inputs the data of the picked-up image in the image processing circuit 20 via the A/D converter 16 (S201). With the sequentially input image data, the image processing circuit 20 performs predetermined calculations for use in the AE (auto-exposure) processing and the AF (auto-focus) processing in the TTL (Through The Lens) method.

In each processing, particular portions of all pixels used in image-pickup operation are selected and extracted as required for use in the calculations. This enables optimal calculations for each of a center-weighted mode, an averaged mode, and an evaluation mode in each processing of the AF, AE, and AWB of the TTL method.

Next, the system controller 50 uses the calculation results in the image processing circuit 20 to perform exposure (AE) control with a combination of the aperture 304 and the electronic shutter of the image-pickup device 14 (S203) until the AE is determined to be correct (S202). An instruction for driving the aperture is transmitted to the image-pickup lens 300 through serial communication via the communication line 399 between the camera body 100 and the image-pickup lens 300.

When the system controller 50 determines that the exposure (AE) provided through the AE control is correct (S202), it stores at least one of the measurement data and the setting parameters in the internal memory or the memory 52. When the system controller 50 determines that flash illumination is required for picking up an image at the correct exposure, it sets a flash flag. The flash flag is stored in the internal memory of the system controller 50 or the memory 52.

The system controller 50 uses the calculation results in the image processing circuit 20 and the measurement data provided in the AE control to perform auto white balance (AWB) control (S207) until the AWB is determined to be correct (S206). The AWB control involves adjusting the parameters for color processing with the image processing circuit 20.

When the white balance (AWB) is determined to be correct (S206), the system controller 50 stores at least one of the measurement data and the setting parameters in the internal memory or the memory 52.

Then, the system controller 50 transmits a focus driving instruction to the image-pickup lens 300 via the communication line 399 to perform the AF control (S209) until it is determined that focusing is achieved (S208). In this event, the lens control microcomputer 306 controls the focus control circuit 302 in accordance with the focus driving amount or the focus driving speed provided from the system controller 50 to drive the focus lens of the image-pickup optical system 301 in the optical axis direction.

The so-called contrast detection method is used for the AF control. This is realized by driving the focus lens in the optical axis direction and setting, as the focus position, the position of the focus lens in the focus detection area of the image where the high-frequency component is at the peak.

After the focusing is determined (S208), the system controller 50 stores at least one of the measurement data and the setting parameters in the internal memory or the memory 52 and ends the photometric measurement and focus detection processing routine (S122).

On the other hand, when the EVF flag is not set at S200, that is, when the OVF mode is set, the flow proceeds to S210 from S200. At S210, the system controller 50 calculates the exposure value based on the photometric measurement results with the photometric sensor 7 and the set sensitivity of the image-pickup device 14 (S211).

Next, the system controller 50 determines whether or not the defocus amount detected in the TTL phase difference detection method by the focus detection unit 8 falls within a predetermined in-focus range (S212). When it falls within the in-focus range, the photometric measurement and focus detection processing is finished. When it is out of the in-focus range (S212), the system controller 50 performs AF control by driving the focus lens (S213) similarly to S209, and the flow returns to S212 to determine whether or not focusing is achieved.

FIGS. 5 and 6 show flow charts of the details of the exposure processing and the writing processing in the image-pickup processing at S129 of FIG. 3. In FIGS. 5 and 6, the same circled letters show that they are linked.

The system controller 50 proceeds to S301 when the EVF flag stored in the internal memory or the memory 52 is set (the EVF mode is set) at S300. At S301, the system controller 50 controls the shutter control circuit 40 to close the front curtain of the shutter 9 which was opened in the EVF mode.

Next, the system controller 50 determines whether or not the power source 405 of the flash unit 400 mounted on the hot shoe 410 is on and whether or not the flash flag stored in the internal memory or the memory 52 is set (S302). When the power source 405 is on and the flash flag is set, the flow proceeds to S303.

At S303, the system controller 50 performs the photometric measurement of the object with the light-controlling sensor 12 before preliminary light emission (hereinafter referred to as pre-emission), later described. At this point, the object image is formed on the front curtain surface of the shutter 9 by the image-pickup optical system 301, and the luminous flux from that object image, that is, the luminous flux reflected by the front curtain surface passes through the image-forming lens 11 and focuses an image onto the light-controlling sensor 12. The image is photoelectrically converted by the light-controlling sensor 12 and integration is performed for a predetermined time period to perform the photometric measurement of the object under steady light before the pre-emission.

Next, at S304, the pre-emission is performed by the flash unit 400. The pre-emission is light emission of the flash unit 400 with a predetermined amount of light to apply illumination light to the object before image-pickup operation (exposure processing). An instruction for the pre-emission is transmitted to the flash control microcomputer 406 from the system controller 50 with the serial communication via the communication line 499 provided between the flash unit 400 and the camera body 100. The flash control microcomputer 406 has boosted the voltage of the power source 405 with the charging circuit 404 before the instruction for the pre-emission. Upon reception of the instruction for the pre-emission, the flash control microcomputer 406 controls the light-emission control circuit 403 to cause the discharge of the Xe tube 401 to perform the pre-emission with the predetermined light amount. The control of flash light emission including the pre-emission performed at this point and the subsequent main light emission, later described, has been disclosed in Japanese Patent Laid-Open No.H09(1997)-61898 (see Paragraphs 0013 to 0031 and FIG. 1).

Then, the system controller 50 performs the photometric measurement of the object illuminated in the pre-emission with the light-controlling sensor 12 (S305). The luminous flux reflected by the object illuminated in the pre-emission is then reflected by the closed front curtain surface of the shutter 9 and forms an image on the light-controlling sensor 12 by the image-forming lens 11. The image is photoelectrically converted by the light-controlling sensor 12 and integration is performed for a predetermined time period to perform the photometric measurement of the object at the time of the pre-emission.

Next, the system controller 50 subtracts the photometric measurement data under the steady light provided at S303 from the photometric measurement data at the time of the pre-emission provided at S305. Since the output from the light-controlling sensor 12 is logarithmically compressed as described above, the calculations can be achieved by addition and subtraction. As a result, only the luminous flux component reflected by the object in the pre-emission is extracted. Then, the amount of light in the main emission is determined on the basis of the difference between the reflected luminous flux component and the photometric measurement data at the correct light amount in accordance with the sensitivity of the image-pickup device 14 previously stored in the memory, not shown, of the system controller 50 (S306).

Next, in response to the press of the shutter switch SW2, the system controller 50 controls the shutter control circuit 40 and moves the front curtain of the shutter 9 in the open direction (S307) to start exposure of the image-pickup device 14 (S308).

Then, the system controller 50 again determines whether or not the flash flag is set (S309). When the flash flag is set, it provides the light amount in the main light emission determined at S306 for the flash control microcomputer 406 (S310). This allows the flash control microcomputer 406 to perform the main light emission with the provided light amount. The system controller 50 closes the rear curtain of the shutter 9 after the set exposure time period (S311) to finish the charge accumulation on the image-pickup device 14, thereby ending the exposure (S312).

On the other hand, when the EVF mode is not set at S301, the flow proceeds to S321. At S321, the system controller 50 determines whether or not the flash flag is set, and performs the photometric measurement of the object with the photometric sensor 7 by using the luminous flux reflected by the main mirror 1 at the down position before the pre-emission (S322). At this point, the object image is formed on the focus plate 2 by the image-pickup optical system 301 via the main mirror 1, and the image then passes through the image-forming lens 6 and is focused onto the photometric sensor 7. The object image is photoelectrically converted by the photometric sensor 7 and integration is performed for a predetermined time period to perform the photometric measurement of the object under steady light.

Next, similarly to S304, the pre-emission is performed by the flash unit 400 with a predetermined amount of light (S323). Then, the photometric sensor 7 performs the photometric measurement of the object using the luminous flux reflected by the object in the pre-emission (S324) similarly to S303.

Then, the system controller 50 subtracts the photometric measurement data under the steady light provided at S322 from the photometric measurement data at the time of the pre-emission provided at S324 to extract only the luminous flux component reflected by the object in the pre-emission. Since the output from the photometric sensor 7 is logarithmically compressed as described above, the calculations can be achieved by addition and subtraction. The amount of light in the main emission is determined on the basis of the difference between the reflected luminous flux component and the photometric measurement data at the correct light amount in accordance with the sensitivity of the image-pickup device 14 previously stored in the memory, not shown, of the system controller 50 (S325).

Next, in response to the press of the shutter switch SW2, the system controller 50 controls the mirror control circuit 41 to move the main mirror 1 and the sub mirror 3 to the up positions. The system controller 50 transmits an instruction for setting the aperture 304 to a predetermined aperture value to the lens control microcomputer 306 via the communication line 399. The lens control microcomputer 306 controls the aperture control circuit 305 to set the aperture 304 to the predetermined aperture value (S326).

Next, the system controller 50 controls the shutter control circuit 40 to move the front curtain of the shutter 9 in the open direction (S327) to start exposure of the image-pickup device 14 (S328). Then, the system controller 50 again determines whether or not the flash flag is set (S329). When the flash flag is set, the system controller 50 provides the light amount in the main emission determined at S325 for the flash control microcomputer 406 (S330). This allows the flash control microcomputer 406 to perform the main light emission with the provided light amount. The system controller 50 closes the rear curtain of the shutter 9 after the set exposure time period (S331) to finish the charge accumulation on the image-pickup device 14, thereby ending the exposure (S332). At S333, the system controller 50 returns the main mirror 1 and the sub mirror 3 to the down positions from the up positions and drives the aperture 304 to the full-opened state.

The system controller 50 reads the charge signal from the image-pickup device 14 and writes the data of the picked-up image into the memory 30 via the A/D converter 16, the image processing circuit 20, and the memory control circuit 22 (S340). The data of the picked-up image may be written into the memory 30 from the A/D converter 16 via the memory control circuit 22.

Next, the system controller 50 determines whether or not frame processing needs to be performed on the basis of the set image-pickup mode (S341). When it is required, the system controller 50 reads the image data written into the memory 30 and sequentially performs vertical addition processing (S342) and the color processing (S343) thereon by using the memory control circuit 22 and, as required, the image processing circuit 20. Then, the system controller 50 writes the processed image data into the memory 30.

Next, the system controller 50 reads the image data from the memory 30 and transfers the image data for display to the image display memory 24 via the memory control circuit 22 (S344). After the completion of the series of operations, the exposure and writing processing routine (S129) is ended.

FIG. 7 shows a flow chart which represents the details of the recording processing at S134 of FIG. 3.

The system controller 50 reads the data of the picked-up image written into the memory 30 and performs pixel squaring processing thereon with interpolation to provide the ratio of vertical pixels to horizontal pixels of 1:1 by using the memory control circuit 22 and, as required, the image processing circuit 20 (S401). Then, the system controller 50 writes the processed image data into the memory 30.

Next, the system controller 50 reads the image data written into the memory 30 and the image compression/decompression circuit 32 performs image compression processing in accordance with the set mode (S402) The system controller 50 writes the compressed image data on the recording medium 200 via the interface 90 and the connector 92 (S403).

After the writing on the recording medium 200, the system controller 50 ends the recoding processing routine (S134).

As described above, in Embodiment 1, in the EVF mode in which the main mirror 1 is disposed at the up position, the photometric measurement can be performed by the light-controlling sensor 12 separate from the image-pickup device 14 with the luminous flux reflected by the shutter 9. The output from the light-controlling sensor 12 is logarithmically compressed for use in the calculations to set the light amount in the main emission. Thus, the wide range of photometric measurement can be ensured as compared with the photometric measurement using the image-pickup device 14, so that the amount of light emission of the flash unit 400 can be appropriately set for objects at any positions from short to long distances.

In addition, the image-pickup operation in the EVF mode in Embodiment 1 eliminates the need for moving the main mirror 1 to the down position from the up position to perform the photometric measurement and returning the main mirror 1 to the up position to perform the image-pickup operation (the exposure processing). Thus, the release time lag can be reduced.

In Embodiment 1, when the image-pickup operation with flashing is performed in the OVF mode, the light amount in the main emission is set on the basis of the output from the photometric sensor 7. The output from the photometric sensor 7 is logarithmically compressed for use in the calculations to set the light amount in the main emission. As a result, it is possible to realize a single-lens reflex camera which enables appropriate setting of the light amount emitted from the flash unit 400 both in the OVF mode and the EVF mode.

### Embodiment 2

Embodiment 1 has been described in conjunction with the case where the photometric measurement of the object is performed by the light-controlling sensor 12 receiving the luminous flux reflected from the front curtain surface of the closed shutter 9 in the EVF mode. In contrast, Embodiment 2 uses a photoelectric element with an electrically changeable transmittance disposed closer to an object than the shutter 9. The photoelectric element has a low transmittance to reflect and diffuse (scatter) most of an incident luminous flux when electric current is passed through it, while it has a high transmittance to transmit most of the incident luminous flux when no electric current is passed. Such an element is realized by, for example, an electrochromic element.

In Embodiment 2, the photoelectric element is caused to have the low transmittance before the pre-emission, and in this state, photometric measurement is performed with an object image formed on the surface of the photoelectric element closer to the object. This can eliminate the need for the diffusing treatment on the front curtain surface of the shutter 9 as in Embodiment 1 to prevent possible occurrence of ghost due to irregular reflection on the front curtain surface. In addition, the photoelectric element generally switches between operation states faster than the mechanical shutter 9. This allows photometric measurement to be performed by the light-controlling sensor 12 before the opened shutter 9 is closed in the EVF mode, so that the release time lag can be reduced.

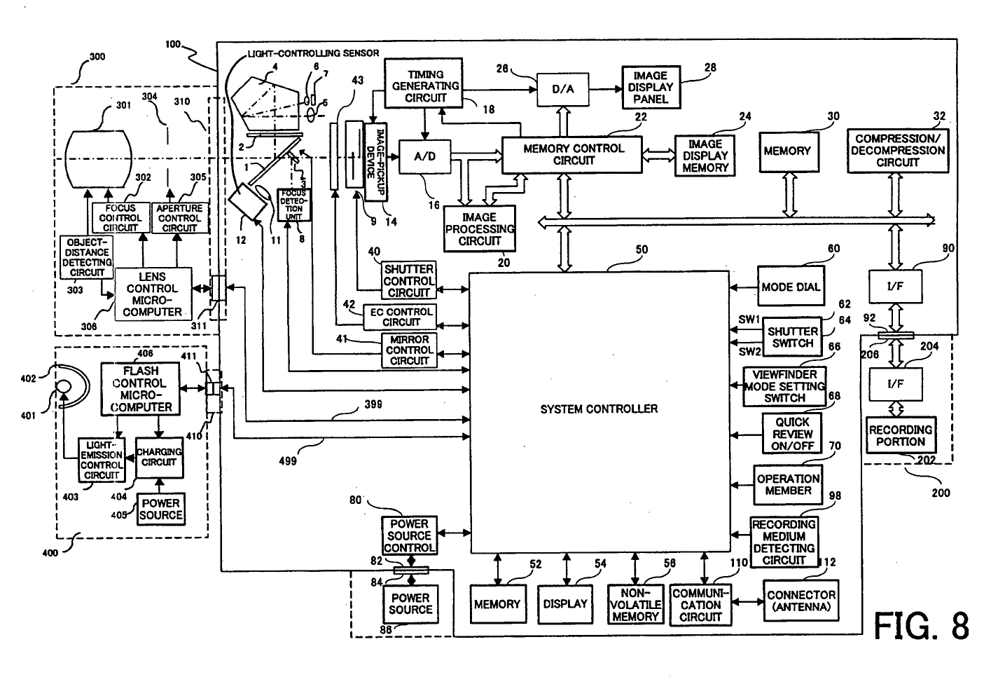

FIG. 8 shows the structure of a single-lens reflex camera system which is Embodiment 2 of the present invention. The components identical to those in Embodiment 1 are designated with the same reference numerals, and the description thereof will be omitted.

In FIG. 8, reference numeral 43 shows the electrochromic element serving as the photoelectrical element. Reference numeral 42 shows an electrochromic control circuit which drives the electrochromic element 43.

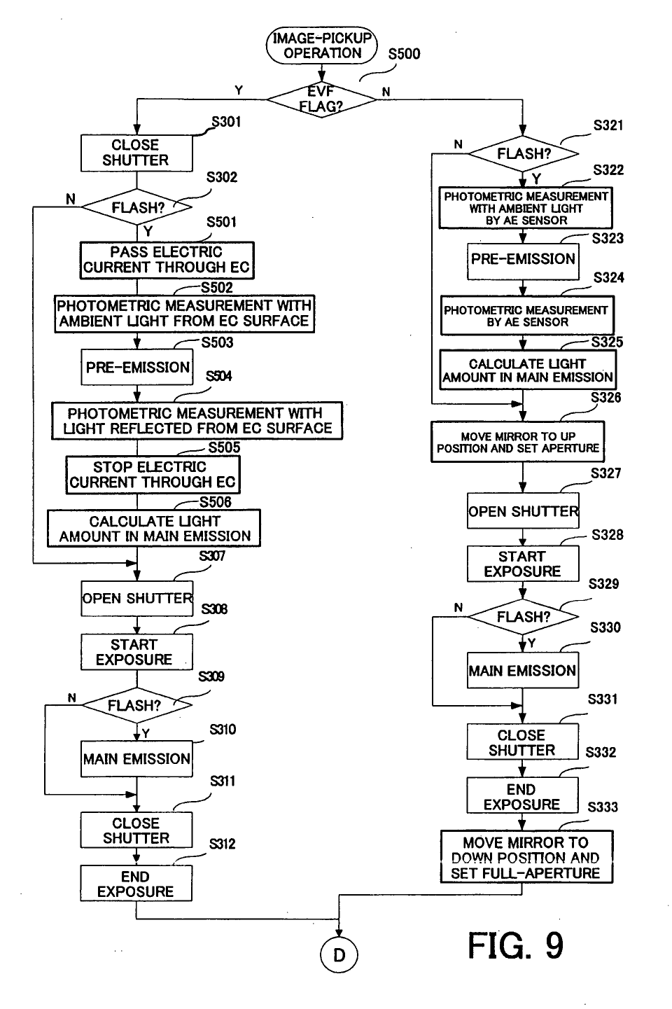

Next, description will be made of the operation of exposure and development processing in the operation of a system controller 50 in Embodiment 2 with reference to flow charts of FIGS. 9 and 6. The flowchart of FIG. 9 is identical to that of FIG. 5 of Embodiment 1 except for S501 to S506 which replace S303 to S306 of FIG. 5. Description will be centered on S501 to S506. The flowchart of FIG. 6 described in Embodiment 1 is also used in Embodiment 2.

The system controller 50 proceeds to S301 when the EVF flag stored in the internal memory or the memory 52 is set (the EVF mode is set). At S301, the system controller 50 controls the shutter control circuit 40 to close the front curtain of the shutter 9 which was opened in the EVF mode. Next, the system controller 50 determines whether or not the power source 405 of the flash unit 400 mounted on the hot shoe 410 is on and whether or not the flash flag stored in the internal memory or the memory 52 is set (S302). When the power source 405 is on and the flash flag is set, the flow proceeds to S501.

At S501, the system controller 50 controls the electrochromic control circuit 42 to pass a predetermined electric current through the electrochromic element 43 to which no electric current was applied (with the high transmittance) in the EVF mode. This causes the electrochromic element 43 to have the low transmittance to reflect and diffuse most of the incident luminous flux. A transmittance closer to 0% is better in this case.

Next, at S502, the system controller 50 performs photometric measurement of an object with the light-controlling sensor 12 before the pre-emission. At this point, an object image is formed on the electrochromic element 43 by the image-pickup optical system 301, and the luminous flux from that object image, that is, the luminous flux reflected by the electrochromic element 43 passes through the image-forming lens 11 and focuses an image on the light-controlling sensor 12. The image is photoelectrically converted by the light-controlling sensor 12 and integration is performed for a predetermined time period to perform the photometric measurement of the object under steady light before the pre-emission.

Next, at S503, the pre-emission is performed by the flash unit 400. An instruction for the pre-emission is transmitted to a flash control microcomputer 406 from the system controller 50 with serial communication via a communication line 499 provided between the flash unit 400 and a camera body 100. The flash control microcomputer 406 has boosted the voltage of the power source 405 with a charging circuit 404 before the instruction for the pre-emission. Upon reception of the instruction for the pre-emission, the flash control microcomputer 406 controls a light-emission control circuit 403 to cause the discharge of the Xe tube 401 to perform the pre-emission with the predetermined light amount. The control of flash light emission including the pre-emission performed at this point and the subsequent main light emission, later described, is performed in the same manner as in Embodiment 1.

Then, the system controller 50 performs the photometric measurement of the object illuminated in the pre-emission with the light-controlling sensor 12 (S504). The luminous flux reflected by the object illuminated in the pre-emission is then reflected and diffused by the electrochromic element 43 with the low transmittance and forms an image on the light-controlling sensor 12 through the image-forming lens 11. The image is photoelectrically converted by the light-controlling sensor 12 and integration is performed for a predetermined time period to perform the photometric measurement of the object at the time of the pre-emission.

Next, the system controller 50 controls the electrochromic control circuit 42 to stop the passage of the electric current through the electrochromic element 43 (S505). This causes the electrochromic element 43 to have the high transmittance to transmit most of the incident luminous flux. A transmittance closer to 100% is better in this case.

Next, the system controller 50 subtracts the photometric measurement data under the steady light provided at S502 from the photometric measurement data at the time of the pre-emission provided at S504. Since the output from the light-controlling sensor 12 is logarithmically compressed as in Embodiment 1, the calculations can be achieved by addition and subtraction. As a result, only the luminous flux component reflected by the object in the pre-emission is extracted. Then, the amount of light in the main emission is determined on the basis of the difference between the reflected luminous flux component and the photometric measurement data at the correct light amount in accordance with the sensitivity of the image-pickup device 14 previously stored in the memory, not shown, of the system controller 50 (S506).

Then, the flow proceeds to S307. At S307 and subsequent steps, the system controller 50 operates in the same manner as in Embodiment 1. In the OVF mode, the system controller 50 operates in the same manner as in Embodiment 1.

As described above, in Embodiment 2, in the EVF mode in which the main mirror 1 is disposed at the up position, the photometric measurement before the pre-emission and in the pre-emission can be performed by the light-controlling sensor 12 separate from the image-pickup device 14 with the luminous flux reflected by the electrochromic element 43. The output from the light-controlling sensor 12 is logarithmically compressed for use in the calculations to set the light amount in the main emission. Thus, the wide range of photometric measurement can be ensured as compared with the photometric measurement using the image-pickup device 14, so that the amount of light emission of the flash unit 400 can be appropriately set for objects at any positions from short to long distances.

In addition, the image-pickup operation in the EVF mode in Embodiment 2 eliminates the need for moving the main mirror 1 to the down position from the up position to perform the photometric measurement and returning the main mirror 1 to the up position to perform the image-pickup operation (the exposure processing). Thus, the release time lag can be reduced.

In Embodiment 2, similarly to Embodiment 1, when the image-pickup operation with flashing is performed in the OVF mode, the light amount in the main emission is set on the basis of the output from the photometric sensor 7. The output from the photometric sensor 7 is logarithmically compressed for use in the calculations to set the light amount in the main emission. As a result, it is possible to realize a single-lens reflex camera which enables appropriate setting of the light amount emitted from the flash unit 400 both in the OVF mode and the EVF mode.

While each of Embodiments 1 and 2 has been described in conjunction with the pre-emission performed before the image-pickup operation and the main emission performed in the image-pickup operation, the present invention is applicable to the case where the flash light emission is performed in the image-pickup operation without performing the pre-emission.

In addition, while each of Embodiments 1 and 2 has been described in conjunction with the camera which has the mirror (the optical-path switching member) movable to the down position in the image-pickup optical path and the up position out of the image-pickup optical path, the present invention is not limited to the image-pickup apparatus which has such an optical-path switching member. For example, the present invention is applicable to an image-pickup apparatus having a mirror which is movable to a position in an image-pickup optical path where it reflects a luminous flux from an image-pickup optical system to a viewfinder optical system, a position where it transmits the luminous flux from the image-pickup optical system to an image-pickup device, and a position where it is retracted from the image-pickup optical path. The present invention is also applicable to an image-pickup apparatus which can move a transparent member having a reflecting film formed partially thereon to a position where the reflecting film is disposed on an image-pickup optical path and a position where a light-transmitting portion without the reflecting film is disposed on the image-pickup optical path.

Furthermore, the present invention is not limited to these preferred embodiments and various variations and modifications may be made without departing from the scope of the present invention.

This application claims foreign priority benefits based on Japanese Patent Application No. 2005-202311, filed on Jul. 11, 2005, which is hereby incorporated by reference herein in its entirety as if fully set forth herein.

What is claimed is:

1. An image-pickup apparatus, comprising:
an image-pickup device which photoelectrically converts an object image;
an electronic display device which displays an image provided by using the image-pickup device;
a viewfinder optical system;
an optical-path switching member which is movable to a first position where the member directs a luminous flux from an object to the viewfinder optical system and a second position where the member directs the luminous flux from the object to the image-pickup device;
a shutter which controls an amount of exposure light to the image-pickup device;
a first light-receiving element; and
a control unit which disposes the optical-path switching member to the second position and opens the shutter to allow observation of the object with the electronic display device, and controls light emission of a flash unit which illuminates the object,
wherein, when image-pickup operation with flashing is performed in an observation state with the electronic display device, the control unit closes the shutter before the image-pickup operation with flashing, and sets an amount of light emission of the flash unit based on an output from the first light-receiving element which receives light reflected by the shutter.

2. The image-pickup apparatus according to claim 1, wherein the control unit performs control to cause the flash unit to perform first light emission before the image-pickup operation with flashing and to cause the flash unit to perform second light emission in the image-pickup operation with flashing, and
the control unit sets an amount of light in the second light emission based on the output from the first light-receiving element in the first light emission.

3. The image-pickup apparatus according to claim 1, wherein the output from the first light-receiving element is logarithmically compressed and input to the control unit.

4. The image-pickup apparatus according to claim 1, further comprising a second light-receiving element,
wherein, when image-pickup operation with flashing is performed in an observation state via the optical-path switching member disposed at the first position and the viewfinder optical system, the amount of light emission of the flash unit is set on the basis of an output from the second light-receiving element.

5. The image-pickup apparatus according to claim 1, wherein the flash unit is detachably attached to the image-pickup apparatus.

6. An image-pickup apparatus, comprising:
an image-pickup device which photoelectrically converts an object image;
an electronic display device which displays an image provided by using the image-pickup device;
a viewfinder optical system;
an optical-path switching member which is movable to a first position where the member directs a luminous flux from an object to the viewfinder optical system and a second position where the member directs the luminous flux from the object to the image-pickup device;
a photoelectric element which is disposed on an optical path from the object to the image-pickup device and has an electrically controllable transmittance;
a first light-receiving element; and
a control unit which disposes the optical-path switching member to the second position and sets the transmittance of the photoelectric element to a first transmittance to allow observation of the object with the electronic display device and controls light emission of a flash unit which illuminates the object,
wherein, when image-pickup operation with flashing is performed in an observation state with the electronic display device, the control unit sets the transmittance of the photoelectric element to a second transmittance lower than the first transmittance before the image-pickup operation with flashing, and sets an amount of light emission of the flash unit based on an output from the first light-receiving element which receives light reflected by the photoelectric element.

7. The image-pickup apparatus according to claim 6, wherein the photoelectric element is an electrochromic element.

8. The image-pickup apparatus according to claim 6, wherein the control unit performs control to cause the flash unit to perform first light emission before the image-pickup operation with flashing and to cause the flash unit to perform second light emission in the image-pickup operation with flashing, and
the control unit sets an amount of light in the second light emission based on the output from the first light-receiving element in the first light emission.

9. The image-pickup apparatus according to claim 6, wherein the output from the first light-receiving element is logarithmically compressed and input to the control unit.

10. The image-pickup apparatus according to claim 6, further comprising a second light-receiving element,
wherein, when image-pickup operation with flashing is performed in an observation state of an object via the optical-path switching member disposed at the first position and the viewfinder optical system, the amount of light emission of the flash unit is set on the basis of an output from the second light-receiving element.

11. The image-pickup apparatus according to claim 6, wherein the flash unit is detachably attached to the image-pickup apparatus.
